(19) United States
(12) Patent Application Publication
(10) Pub. No.: US 2026/0055529 A1
(43) Pub. Date: Feb. 26, 2026

(54) ALUMINUM LITZ WIRE HAVING AN ELECTRICALLY INSULATIVE LAYER

(71) Applicant: Kenyon International, Inc., Clinton, CT (US)

(72) Inventors: Daniel Roy, Westerly, RI (US); Michael Reischmann, Eustis, FL (US)

(21) Appl. No.: 19/305,685

(22) Filed: Aug. 20, 2025

Related U.S. Application Data
(60) Provisional application No. 63/685,082, filed on Aug. 20, 2024.

(51) Int. Cl. C25D 11/02; C25D 11/04

(52) U.S. Cl. CPC C25D 11/026; C25D 11/04

(57) ABSTRACT

Systems and methods are disclosed for an aluminum litz wire. More specifically, there is disclosed an aluminum litz wire wherein the individual aluminum strands therein have insulating layers applied via a corona discharge process.

### RELATED APPLICATIONS

This application claims the benefit of priority to Applicant's U.S. Provisional Patent Application Ser. No. 63/685,082, the entire contents of which are incorporated herein by references for all purposes.

### FIELD OF THE INVENTION

The present disclosure relates to litz wire and more specifically to an aluminum litz wire having an insulating layer applied via a chemical reaction process, such as a layer of aluminum oxide applied by a passivation process such as anodization.

### BACKGROUND

Litz wire, short for the German term litzendraht meaning a braided, stranded or woven wire, is a particular type of multistrand wire or cable used in electronics to carry alternating current at radio frequencies. Typically, the strands of wire are copper which each have a coating of resin so as to be electrically insulated from each other. Litz wires are used in a host of different applications, including, e.g., motors, induction coils, among many other uses.

Litz wire may be woven in a variety of different patterns, e.g., with a first group of wires wound into a small group, that small group being itself wound into a larger group with other previously-wound wires, etc. These winding patterns help equalize the proportion of the overall length over which each strand is at the outside of the conductor, having the effect of distributing the current more equally among the wire strands and reducing the impedance. In other words, the twisting or woven pattern of a litz wire is designed to reduce the skin effect and proximity effect losses in conductors, including up to frequencies of about 1 MHz.

Litz wire have been known to be manufactured using, for example, copper or aluminum wires, resin (or also enamel, varnish or ceramic, although for the purposes of simplicity, the term resin will be employed throughout when referring to any of these) being employed to provide an insulative coating. However, the resin coating on these aluminum litz wires is less than optimal for various different reasons, as will be set forth in greater detail below.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The aluminum litz wire described hereinbelow provides for a plurality of woven, braided, stranded or twisted aluminum wires, one or more of such aluminum wires having an insulating layer applied via a chemical reaction process. An example of such insulating layer is aluminum oxide, although as set forth below, various other layers may be employed, such as aluminum fluoride, aluminum nitride among others. An example of such chemical reaction process is a chemical passivation process, such as anodization or forming an oxidation via application of a corona discharge treatment, or by chemical vapor deposition, other such chemical reaction processes also being contemplated. As an initial matter, for the purposes of this description, it should be recognized that the terms woven, braided, stranded and twisted are used interchangeably throughout and are intended to refer to any arrangement or pattern by which the wires may be combined in a litz wire. Likewise, for the purposes of this description, it should be recognized that the terms cables, wires and strands are also used interchangeably throughout.

It should also be recognized that, while the term “layer” is used above and throughout, it should be noted that a typical passivation process, for example an anodization process, has both penetrative and growth effects, e.g., the oxide or other passivation material both penetrates the wire to which it is applied while also slightly growing the outer diameter of the wire, as will be described in greater detail below.

According to various embodiments, there is provided a litz wire that includes a plurality of individual aluminum strands, at least one of the aluminum strands having an insulative layer applied via a chemical reaction process. For the purposes herein, it should be noted that aluminum and its alloys may be suitable, including but not limited to aluminum 1000 through 8000 series, such as aluminum alloy 1350 that is commonly employed for aluminum wires. In some embodiments of the litz wire, all of the individual aluminum strands may have an insulative layer applied via the chemical reaction process. The insulative layer may be applied to the at least one aluminum strand via, e.g., a passivation process such as an anodization process. Advantageously, the aluminum strands may have an insulative layer of aluminum oxide. The litz wire may include an outer sheath surrounding the litz wire. The plurality of aluminum strands may have cross-sectional shapes selected from round, oval, square and elliptical.

The plurality of individual aluminum strands may be woven together in any conceivable pattern. In an embodiment, the plurality of individual aluminum strands may include a first group of individual strands that are woven together, and the plurality of individual aluminum strands may also include a second group of individual strands that are woven together, the first group and second group of individual strands also being woven together.

In embodiments, in order to remove the oxide layer from the aluminum strands, the aluminum strands may have ends that are flash-melted. Additionally or alternatively, in order to remove the oxide layer from the aluminum strands, the oxide layer may be removed from the ends of the aluminum strands either chemically and/or mechanically, and then be braised, welded, soldered or crimped. Advantageously, the litz wire may be configured for use in applications experiencing temperatures greater than 400° F.

According to other various embodiments, there is also provided a method of manufacturing a litz wire. The method may include the steps of providing a plurality of aluminum strands, applying to the plurality of aluminum strands an electrically-insulative layer material using a chemical reaction process. The chemical reaction process could be a chemical passivation process, a corona discharge treatment, among other types of processes. The method may also include the step of combining the plurality of coated aluminum strands into a wire. The applying step may include applying to all of the aluminum strands an electrically-insulative layer material using such chemical reaction process. The applying step may include applying the insulative layer to the at least one aluminum strand via an anodization process. The applying step may include applying to the at least one aluminum strand an insulative layer of aluminum oxide.

The method may also include the step of surrounding the litz wire with an outer sheath, e.g., a serve. The cross-sectional shape of the aluminum strands may be selected from round, oval, square and elliptical. The combining step may include weaving the plurality of individual aluminum strands together. For example, the weaving step may include weaving together a first group of individual aluminum strands, weaving together a second group of individual aluminum strands, and then weaving together the first group and second group of individual strands.

The method may also include the step of removing the oxide layer from an end of the at least one aluminum strand by, e.g., flash-melting or any other chemical or mechanical process, and then braising, welding, soldering or crimping it. Advantageously, the litz wire may be used in an application experiencing temperatures greater than 400° F.

According to various embodiments, there is also provided a litz wire comprising a plurality of individual aluminum strands, at least one of the aluminum strands having an insulative layer applied via a corona discharge treatment process. In embodiments, all of the individual aluminum strands may have an insulative layer applied via a corona discharge treatment process. The at least one aluminum strand may have an insulative layer selected from one of aluminum oxide, aluminum fluoride or aluminum nitride. The plurality of individual aluminum strands may be woven together. In various embodiments, the plurality of individual aluminum strands may include a first group of individual strands that are woven together, and the plurality of individual aluminum strands may also include a second group of individual strands that are woven together, and the first group and second group of individual strands may also be woven together.

According to various embodiments, the at least one aluminum strand may have an end that is one of flash-melted, braised, welded, soldered or crimped. The litz wire may be configured for use in an application experiencing temperatures greater than 400° F. The litz wire may also include an outer sheath or serve surrounding the litz wire. The plurality of aluminum strands may have cross-sectional shapes selected from round, oval, square and elliptical. In embodiments, the insulative layer may be applied to the at least one of the aluminum strands in a continuous flow process. The continuous flow process may include keeping the strands at a very high potential relative to adjacent electrodes as the strands are spooled onto individual bobbins or spun into the litz wire.

According to still further various embodiments, there is also provided a method of manufacturing a litz wire. The method may include the step of providing a plurality of aluminum strands. The method may also include the step of applying to the plurality of aluminum strands an electrically-insulative layer material using a corona discharge treatment process. The method may also include the step of combining the plurality of coated aluminum strands into a wire. In embodiments, the applying step may include applying the insulative layer to the at least one of the aluminum strands in a continuous flow process. In further embodiments, the continuous flow process may also include keeping the strands at a very high potential relative to adjacent electrodes as the strands are spooled onto individual bobbins and/or as the strands are spun into the litz wire.

In embodiments, the applying step may include applying to the at least one aluminum strand an insulative layer of aluminum oxide, aluminum fluoride or aluminum nitride. In further embodiments, the combining step may include weaving the plurality of individual aluminum strands together. The weaving step may include weaving together a first group of individual aluminum strands, weaving together a second group of individual aluminum strands, and then weaving together the first group and second group of individual strands. In still further embodiments, the method may also include the step of at least one of flash-melting, braising, welding, soldering or crimping an end of the at least one aluminum strand. In still further embodiments, the method may also include the step of surrounding the litz wire with an outer sheath or serve.

As an initial matter, aluminum litz wires may, in certain circumstances and frequency ranges, already be an improvement over previously-employed copper litz wires. For example, the July 2011 article in How2PowerToday entitled “Why use Aluminum Wire” by Dennis Feucht, which is incorporated in its entirety herein by reference thereto, describes various reasons and circumstances under which an aluminum wire is an improvement over copper wire. For example, aluminum wire has a thicker skin depth than copper wire. Skin depth is the cross-sectional depth, measured from the outer circumference of a wire or strand, along which conduction primarily occurs and it is in this region of the wire that most of the flow of electrons occur. Thus, a litz wire that employs individual copper strands, as is common in previously-employed litz wires, may experience lesser conductivity as a result of the copper wires having skin depths having less cross-sectional area for electrons to flow. By contrast, aluminum wires may have a thicker skin depth as compared to copper, and thus, in certain circumstances, may provide increased conductivity. The afore-mentioned article demonstrates that, e.g., a single strand of copper wire having equal diameter and temperature to aluminum wire will always have a lower total resistance than the aluminum wire, except when the wires are in the presence of an externally-applied, time-changing, magnetic field. In the presence of the externally-applied time-changing magnetic field, the current density within the wire cross-section is reduced by the induced eddy currents due to the applied field, in accordance with Faraday's law of induction. The origin of the external applied magnetic fields are most commonly those fields from adjacent windings within a coil such as those encountered in transformers, inductors, and motors, but are also commonly encountered in electrodynamic transducers such as voice-coils and linear motors, among other electric and magnetic machines.

However, previously-employed aluminum litz wire, which are typically coated in a fashion similar to copper litz wires, namely by the individual braided strands therein being insulatively coated with a resin, also have their disadvantages for which the present description may provide significant improvements. Putting aside the benefits that aluminum conductors may already have over copper conductors (e.g., aluminum being a lighter/cheaper material than copper, the low total resistance of aluminum wire under certain conditions where the proximity effect more detrimentally effects the copper wire than the aluminum wire, etc), the presently described systems and method also have the additional benefits over previously-employed aluminum litz wire of, e.g., having a better packing factor (e.g., the ratio of conductor cross-section to insulation or non/conductor cross-section), having a higher maximum operating temperature than resin-coated wires, having a better thermal conductivity than aluminum wire insulated with resin, exhibiting less proclivity to spalling than ceramic coatings which are the presently-employed insulation types when very high temperature performance is required, a minimization or elimination of outgassing, and an improved tolerance of corona discharge (which itself is a leading cause of failure of enamel coated wires and the machines employing them). Some of these additional advantages are described in more detail below.

For example, coating individual aluminum wires with resin, as is performed in previously-employed aluminum litz wires, is expensive and difficult to achieve. By contrast, aluminum oxide is less expensive than resin. In addition, applying to the aluminum wires an insulating layer, e.g., a layer of aluminum oxide, applied by a chemical reaction, e.g., passivation, process can be achieved relatively easily. Processes such as an anodization or corona discharge treatment process may be cheaper and easier than coating aluminum wires with resin. Thus, aluminum litz wire having, e.g., aluminum oxide, insulative layers on its aluminum wires applied by a chemical reaction process, e.g., a passivation process such as anodization, as described hereinbelow, is a cheaper and easier alternative to manufacturing copper litz wires and/or aluminum litz wires that employ resin as their insulative coatings.

In addition, the resin coating employed to coat individual aluminum wires, as is performed in previously-employed aluminum litz wires, results in a relatively thick coating of resin. Because the coatings on each individual wire strand is relatively thick, fewer such wires can be employed in a litz wire of a given size, thereby resulting in a relative reduction in conductivity. Likewise, because the resin coating on each individual wire strand is relatively thick, there is a relatively larger amount of air space within the litz wire, the relatively increased air space resulting in fewer such wires being employed (again, resulting in a relative reduction in conductivity because less wires are present). By contrast, electrically-insulative layers, e.g., an aluminum oxide, can be applied, such as by an anodization process or any other chemical reaction or passivation process, less thickly on an aluminum wire. This relatively thinner insulative layer, e.g., of aluminum oxide, may result in each individual aluminum strand having a smaller cross-sectional area and thus enables the aluminum litz wire to include relatively more individual aluminum strands and less air space therebetween, so as to provide improved conductivity relative to copper litz wires and/or aluminum litz wires that employ resin as its insulative coating.

By way of example, a resin coating as commonly applied to wires may typically have a thickness ranging from, e.g., from 2.5 mils to 5 mils. Thus, for a 40 AWG wire that without insulation has a diameter of about 3.1 mils, the resin coating would more than double the diameter of the wire to about 8.1 mils. A round copper wire having these dimensions would consequently have a cross-sectional area of copper of about 7.55 square mils, while the cross-sectional area of the resin would be about 44 square mils (with the total cross-sectional area of both the wire and the resin being about 51.5 square mils). In contrast, an electrically-insulative layer, e.g., an aluminum oxide, that is applied, such as by an anodization process or any other chemical reaction or passivation process, to an aluminum wire, typically adds less than 0.5 mils to the outer diameter of the wire, thereby providing significantly improved cross-sectional area (recognizing that the oxide penetration into the wire has a slight impact on this as well).

In addition, previous aluminum litz wires that are employed in very high temperature environments often have a ceramic coating employed to coat individual aluminum wires. These ceramic coatings are particularly prone to experiencing spalling, e.g., breaking or cracking, decreasing the wires effectiveness as a conductor and reducing its reliability over time. In contrast, applying to the individual strands of an aluminum litz wire an electrically-insulative layer, e.g., an aluminum oxide layer, via a chemical reaction process, e.g., a chemical passivation or an anodization process, may help reduce or eliminate the likelihood of spalling, rendering such an aluminum litz wire more reliable and durable over time.

Still further, the resin (e.g., enamel and varnish) coatings employed to coat individual aluminum wires in previously-employed aluminum litz wires can undesirably result in outgassing. Outgassing may occur when the resin/enamel/varnish coatings employed to coat previously-employed aluminum litz wires are subject to high temperatures and vacuums, and causes volatile compounds from the resin to become airborne and condense on adjacent critical components, especially optical components, which thereby degrades the system performance (see, for example, the May 28, 2024 article entitled “Outgassing: the Hidden Dangers” in CINCH Connnectivity Solutions at https://www. cinch. com/resources/tech-paper/outgassing-the-hidden danger). This challenge may be particularly problematic in military and aerospace applications. In contrast, applying an electrically-insulative layer of, e.g., an aluminum oxide layer, via a chemical reaction process, e.g., a chemical passivation or an anodization process, may help reduce or eliminate outgassing and avoid these challenges.

Furthermore, the industry has tended to avoid the use of oxide, and specifically aluminum oxide, in the manufacture of litz wires. Generally, it has been a concern that oxide, if present on the contacts of the wires, will corrode the contacts and increase the resistance therethrough, making it less effective as a conductor. By contrast, as described hereinbelow, aluminum litz wires that are manufactured so as to have an electrically-insulative layer applied by a chemical passivation process, e.g., an anodized layer of aluminum oxide thereon, may help eliminate or decrease the likelihood of such oxide being present on the wire's contacts, and thus avoid the detrimental impacts to conductivity.

The aluminum litz wire described herein, according to various embodiments, also addresses various other challenges facing previously-employed litz wires. For example, the resin coating employed to coat individual copper or aluminum wires, as is performed in previously-employed litz wires, limits the applications for which a given litz wire may be employed. The commonly-employed resins typically have a melt temperature of, e.g., approximately 400° F., preventing such litz wires from being employed in applications where the litz wire is likely to experience temperatures higher than 400° F. By contrast, electrically-insulative layers applied via a chemical passivation process, e.g., an aluminum oxide applied via an anodization process, is not limited to about 400° F., but instead is only limited by, in this example embodiment, the much higher melt temperature of aluminum, e.g., approximately 1,221° F. This much higher melt temperature enables a litz wire as described herein to be used in a broader array of applications, specifically those applications for which the litz wire is expected to experience much higher temperatures. Some of these applications may include high power density electronic devices, high power density electric motors, downhole power supplies and motors, and engine compartment power supplies, among countless others.

It should also be noted that the presently-described inventions have the additional benefit of the aluminum oxide being more tolerant of the deleterious effects of corona discharge. A corona discharge is an electrical discharge brought on by the ionization of a fluid such as air surrounding a conductor that is electrically charged and is a leading cause of failure of enamel-insulated wire and the devices that utilize the wire. In contrast, aluminum litz wires as presently described herein fare better under such corona discharge, and in fact, the oxide layer of same may be enhanced in the presence of corona discharge because the corona discharge may actually result in the deposit of more oxide on the wire.

### DRAWINGS

FIG. 1 shows a cutaway perspective view of a litz wire, in accordance with various embodiments.

FIG. 2 shows a schematic cross-sectional view of an exemplary litz wire, in accordance with various embodiments.

FIGS. 3A and 3B depict front and rear perspective views of one exemplary use case for the litz wire in accordance with one embodiment.

### DETAILED DESCRIPTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and/or components have not been described in detail so as not to unnecessarily obscure aspects of the embodiments.

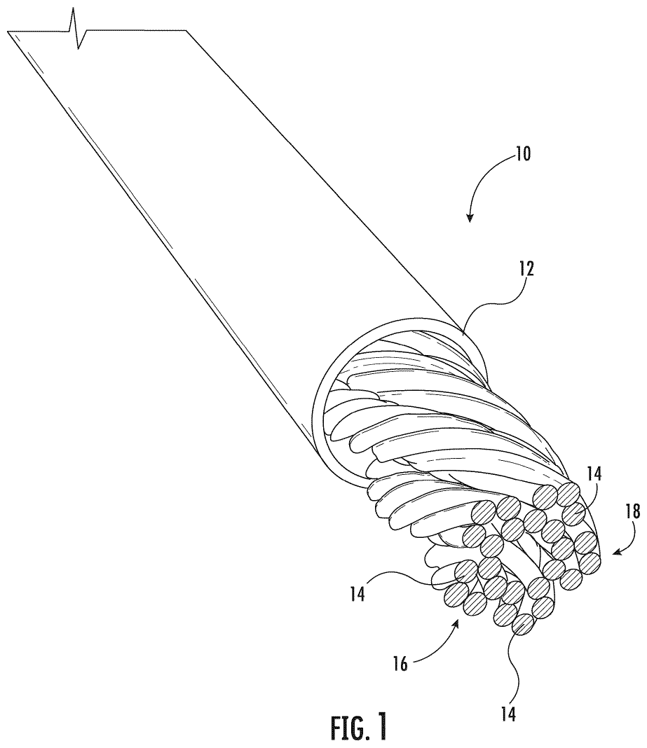

As set forth above, FIG. 1 is a perspective view that illustrates a litz wire 10, according to various embodiments. The litz wire 10 includes an outer sheath 12, commonly referred to as a serve, within which is disposed a plurality of wires/strands 14 (only some of which are labelled here so as to avoid cluttering the figure). In other embodiments, the outer sheath or serve may be eliminated. Some of these strands 14, in this example five such strands, are woven into a first group 16 of strands, while still other of these strands 14, again five in this example, are woven into a second group 16 of strands, etc. In the example shown, there are five such groups (only the first two groups 16 and 18 being labelled, again to avoid cluttering the figure). However, it should be recognized that, while this example shows five strands 14 forming a particular group, any number of strands 14 may be employed to form a group. In addition, it should be recognized that, while this example shows five groups 16, 18 of individual strands 14 within the litz wire 10, any number of groups of strands 14 may be employed within the litz wire 10. Furthermore, it should be recognized that any conceivable pattern for weaving, twisting or braiding the individual strands 14 may be employed within the litz wire 10. It should also be recognized that, while the individual strands 14 and the overall litz wire 10 itself are shown to be generally round in cross-sectional shape, the individual strands 14 and the overall litz wire 10 itself may have any conceivable cross-sectional shape, e.g., round, oval, square, elliptical, or any other shape without limitation.

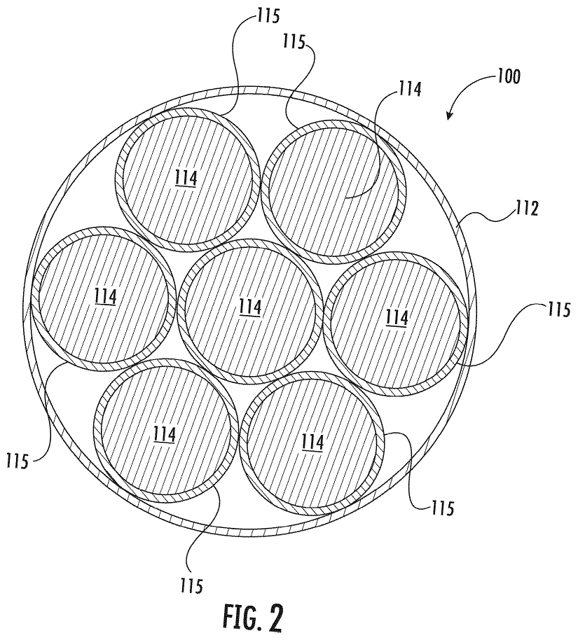

FIG. 2 is a cross-sectional view that schematically illustrates a litz wire 110, according to various embodiments. In this view, there is shown a single group formed from seven individual aluminum strands 14. Of course, as mentioned above in connection with FIG. 1, this embodiment of aluminum litz wire 110 is merely exemplary and it should be recognized that litz wire 110 may include any number of strands 114 to form a group, and any number of groups of strands 114 may be employed within the litz wire 110, in any conceivable pattern.

As shown in FIG. 2, each of the individual aluminum strands 114 includes a layer 115. The layer 115 shown here is merely schematic and is intended only to demonstrate the layers surrounding each of the strands 114, the thickness of such layers 115 not being to scale. As mentioned above, the layers 115 on each of the strands 114 (shown in FIG. 2 on all of the strands 114 although fewer than all of the strands 114, including just one strand 114, may be applied as such) are an electrically-insulating layer that is applied to the strand 114 via any chemical reaction process. One such chemical reaction process is a passivation process, such as an anodization process, which is a type of electrochemical redox reaction or oxidation-reduction reaction. Generally, an oxidation-reduction (redox) reaction involves the transfer of electrons from a reducing agent to an oxidizing agent. Other types of chemical passivation processes, such as a corona discharge treatment process or a chemical vapor deposition process, are also contemplated herein.

In various embodiments, the layer 115 that is applied by, e.g., an anodization process, may be a layer of aluminum oxide, although layers formed from other materials are also contemplated herein. For example, the layer 115 that is applied by a chemical reaction process may, instead of being a layer of aluminum oxide, be a layer of aluminum fluoride, may be a layer of aluminum nitride, or may be a layer of other elements.

As set forth above, aluminum litz wire that has its individual aluminum strands insulated by an insulating oxide layer, e.g., aluminum oxide among others, applied by a chemical reaction process, e.g., a chemical passivation process such as an anodization process among others, provides various advantages over typical copper litz wires and over previously-employed aluminum litz wires that use resin as its insulative layer of the aluminum strands. For example, for at least the reasons set forth above, they may be cheaper and easier to apply than resin, may enable each individual aluminum strand to have a smaller cross-sectional area and thus the aluminum litz wire to include relatively more individual aluminum strands and less air space therebetween, may provide improved thermal conductivity, may enable use in a broader array of applications including those applications for which the litz wire is expected to experience much higher temperatures, may reduce the proclivity to spalling experienced by ceramic-coated wires, may eliminate or reduce outgassing, and may provide a product that is more tolerant of and in fact may benefit from corona discharge effects.

Expounding upon an example, because aluminum has a lower conductivity than copper, 37 AWG aluminum wire may be used (and may have the same or slightly lower resistance as an 40 AWG copper wire). The 37 AWG aluminum diameter is 4.45 mils, and after anodization with aluminum oxide, the outer diameter of the wire grows to about 4.55 mils. The outer conductive region of the base metal is oxidized inward resulting in a usable conducting diameter of 4.35 mils (which is still slightly less resistive than the 40 AWG copper). Each strand of the aluminum wire (including insulation) uses 16.3 square mils.

The ratio of cross-sectional area used by the resin-coated copper wire to the anodized aluminum wire is 51.5/16.3 (or 3.16) to achieve the same electrical resistance. Additionally, because of the deeper skin depth, the anodized aluminum litz wire maintains its performance to a higher frequency than the resin-coated copper. As a result, less total cross-sectional area is needed by the aluminum wire to achieve the same resistance as the copper wire.

It should be evident, therefore, that the “crossover” diameter—e.g., the diameter at which the total-wire-plus-insulation diameters of the copper and anodized aluminum strands are equal -occurs at approximately a diameter of 36 AWG. This 36 AWG diameter corresponds to an operating frequency of about 20-50 KHz. For devices with operation frequencies above 50 KHz, (e.g., inductors and transformers) an aluminum litz wire having an aluminum oxide layer applied via a chemical passivation process such as anodization, will be more compact than a copper wire while still achieving the same performance, being less massive, less expensive and available for use at higher operating temperatures before failure, for all of the reasons set forth above. Still further, for at least all of these reasons, an anodized aluminum litz is more cost effective, compact, lightweight, and better performing than a copper wire for the myriad of magnetic devices that are currently being made to operate at higher frequencies, e.g., currently employed SiC and GaN devices that operate between, e.g., 100 and 800 KHz.

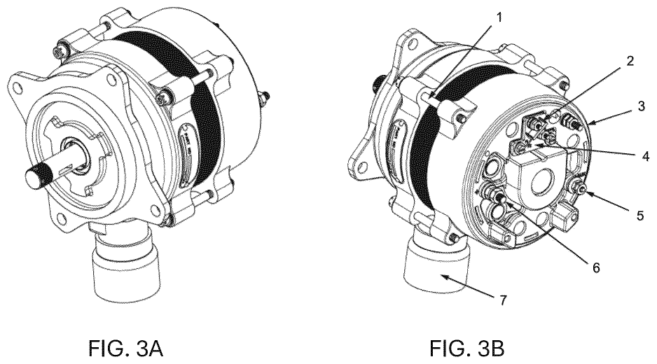

One exemplary use case for the litz wire according to the present disclosure is in an aircraft alternator, an example of which is depicted in FIGS. 3A and 3B. Such an application provides for space and weight savings in an aircraft along with the resulting reduction in nose weight and corresponding lesser impact on the aircraft center of gravity and loading as the alternator is very often found at the very front of the plane, just behind the propeller for belt driven models or is attached at the accessory case at the rear of the engine in the example depicted in FIGS. 3A and 3B. The alternator shown in FIGS. 3A and 3B. includes through bolts 1, a field terminal 2, a ground terminal 3, the brush assembly 4, an aux terminal 5, the output terminal 6 and a flexible cooling duct 7. The litz wire is wound within the housing as part of the alternator as would be understood by those of skill in the art. The aircraft alternator is but one example, others include induction coils, motors and other applications including inductors, as but some non limiting examples.

There are no limitations in terms of the particular embodiments described in this application, which are intended as illustrations of various aspects only. Many modifications and variations can be made without departing from its spirit and scope, as will be apparent to those skilled in the art. Functionally equivalent methods and apparatuses, in addition to those enumerated herein, will be apparent to those skilled in the art from the foregoing descriptions. Such modifications and variations are intended to fall within the scope of the appended claims. Only the terms of the appended claims are intended to be limiting, along with the full scope of equivalents to which such claims are entitled. It is also to be understood that the terminology used herein, e.g., “and”, “or”, “including”, “at least” as well as the use of plural or singular forms, etc., is for the purpose of describing examples of embodiments and is not intended to be limiting.

What is claimed is:

1. A litz wire comprising:
a plurality of individual aluminum strands, at least one of the aluminum strands having an insulative layer applied via a corona discharge treatment process.

2. The litz wire of claim 1, wherein all of the individual aluminum strands have an insulative layer applied via a corona discharge treatment process.

3. The litz wire of claim 1, wherein the at least one aluminum strand has an insulative layer selected from one of aluminum oxide, aluminum fluoride or aluminum nitride.

4. The litz wire of claim 1, wherein the plurality of individual aluminum strands are woven together.

5. The litz wire of claim 4, wherein the plurality of individual aluminum strands include a first group of individual strands that are woven together, and the plurality of individual aluminum strands also include a second group of individual strands that are woven together, the first group and second group of individual strands also being woven together.

6. The litz wire of claim 1, wherein the at least one aluminum strand has an end that is one of flash-melted, braised, welded, soldered or crimped.

7. The litz wire of claim 1, wherein the litz wire is configured for use in an application experiencing temperatures greater than 400° F.

8. The litz wire of claim 1, further comprising an outer sheath or serve surrounding the litz wire.

9. The litz wire of claim 1, wherein the plurality of aluminum strands have cross-sectional shapes selected from round, oval, square and elliptical.

10. The litz wire of claim 1, further comprising an aircraft alternator, wherein the aircraft alternator includes the litz wire.

11. The litz wire of claim 1, wherein the continuous flow process includes keeping the strands at a very high potential relative to adjacent electrodes as the strands are spooled onto individual bobbins or spun into the litz wire.

12. A method of manufacturing a litz wire comprising the steps of:
providing a plurality of aluminum strands;
applying to the plurality of aluminum strands an electrically-insulative layer material using a corona discharge treatment process;
combining the plurality of coated aluminum strands into a wire.

13. The method of claim 12, wherein the applying step includes applying the insulative layer to the at least one of the aluminum strands in a continuous flow process.

14. The method of claim 13, wherein the continuous flow process includes keeping the strands at a very high potential relative to adjacent electrodes as the strands are spooled onto individual bobbins.

15. The method of claim 13, wherein the continuous flow process includes keeping the strands at a very high potential relative to adjacent electrodes as the strands are spun into the litz wire.

16. The method of claim 12, wherein the applying step includes applying to the at least one aluminum strand an insulative layer of aluminum oxide, aluminum fluoride or aluminum nitride.

17. The method of claim 12, wherein the combining step includes weaving the plurality of individual aluminum strands together.

18. The method of claim 17, wherein the weaving step includes weaving together a first group of individual aluminum strands, weaving together a second group of individual aluminum strands, and then weaving together the first group and second group of individual strands.

19. The method of claim 12, further comprising the step of:
at least one of flash-melting, braising, welding, soldering or crimping an end of the at least one aluminum strand.

20. The method of claim 12, further comprising the step of:
surrounding the litz wire with an outer sheath or serve.
